(19) United States
(12) Patent Application Publication
(10) Pub. No.: US 2007/0299994 A1
(43) Pub. Date: Dec. 27, 2007

(54) Disk controller, host interface module and methods for use therewith

(75) Inventor: Kevin W. McGinnis, Berthoud, CO (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/472,129

(22) Filed: Jun. 21, 2006

(51) Int. Cl. G06F 13/38

(52) U.S. Cl. 710/62

(57) ABSTRACT

A host interface module is operable to couple the disk drive to a host device. The host interface module includes a plurality of personality modules, each of the plurality of personality modules, when coupled to the host device, is operable to accept read and write commands and transfer data to and from the host device in a corresponding one of a plurality of host interface protocols. A universal host module decodes read and write commands from the host device and transports data written to and read from the disk drive via a first of the plurality of personality modules. A multiplexer selectively couples the first of the plurality of personality modules to the universal host module in response to a selection signal. A system interface couples the universal host module to a processor and a memory of the disk controller.

### BACKGROUND OF THE INVENTION

1. Technical Field of the Invention

The present invention relates to disk controllers, disk drives and related methods.

2. Description of Related Art

As is known, many varieties of disk drives, such as magnetic disk drives are used to provide data storage for a host device, either directly, or through a network such as a storage area network (SAN) or network attached storage (NAS). Typical host devices include stand alone computer systems such as a desktop or laptop computer, enterprise storage devices such as servers, storage arrays such as a redundant array of independent disks (RAID) arrays, storage routers, storage switches and storage directors, and other consumer devices such as video game systems and digital video recorders. These devices provide high storage capacity in a cost effective manner.

The disk drive includes a host interface module that provides control, status and data transfer between the host device and the disk drive, generally in any one of a number of standard interface formats. The use of a standard interface format allows plug and play functionality for any drives that incorporate the particular format of the host. However, use of multiple standard formats by different hosts requires disk drives to include customized host interface modules for different host application.

Further limitations and disadvantages of conventional and traditional approaches will become apparent to one of ordinary skill in the art through comparison of such systems with the present invention.

### BRIEF DESCRIPTION OF THE SEVERAL VIEWS OF THE DRAWINGS

FIG. 1 presents a pictorial representation of a disk drive unit 100 in accordance with an embodiment of the present invention.

FIG. 2 presents a block diagram representation of a disk controller 130 in accordance with an embodiment of the present invention.

FIG. 3 presents a block diagram representation of a host interface module 150 in accordance with an embodiment of the present invention.

FIG. 4 presents a block diagram representation of a configuration module 260 in accordance with an embodiment of the present invention.

FIG. 5 presents a pictorial representation of a handheld audio unit 51 in accordance with an embodiment of the present invention.

FIG. 6 presents a pictorial representation of a computer 52 in accordance with an embodiment of the present invention.

FIG. 7 presents a pictorial representation of a wireless communication device 53 in accordance with an embodiment of the present invention.

FIG. 8 presents a pictorial representation of a personal digital assistant 54 in accordance with an embodiment of the present invention.

FIG. 9 presents a pictorial representation of a laptop computer 55 in accordance with an embodiment of the present invention.

FIG. 10 presents a flowchart representation of a method in accordance with an embodiment of the present invention.

FIG. 11 presents a flowchart representation of a method in accordance with an embodiment of the present invention.

### SUMMARY OF THE INVENTION

The present invention sets forth a disk controller, host interface module and methods for use therewith substantially as shown in and/or described in connection with at least one of the figures, as set forth more completely in the claims that follow.

### DETAILED DESCRIPTION OF THE INVENTION INCLUDING THE PRESENTLY PREFERRED EMBODIMENTS

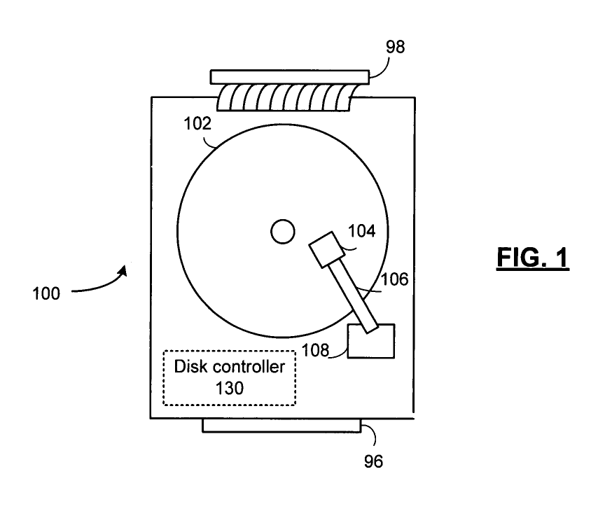

FIG. 1 presents a pictorial representation of a disk drive unit 100 in accordance with an embodiment of the present invention. In particular, disk drive unit 100 includes a disk 102 that is rotated by a servo motor (not specifically shown) at a velocity such as 3600 revolutions per minute (RPM), 4200 RPM, 4800 RPM, 5400 RPM, 7200 RPM, 10,000 RPM, 15,000 RPM, however, other velocities including greater or lesser velocities may likewise be used, depending on the particular application and implementation in a host device. In an embodiment of the present invention, disk 102 can be a magnetic disk that stores information as magnetic field changes on some type of magnetic medium. The medium can be a rigid or nonrigid, removable or nonremovable, that consists of or is coated with magnetic material.

Disk drive unit 100 further includes one or more read/write heads 104 that are coupled to arm 106 that is moved by actuator 108 over the surface of the disk 102 either by translation, rotation or both. In an embodiment of the present invention, the read/write heads 104 include a write element that writes data on the disk via longitudinal magnetic recording, perpendicular magnetic recording or other magnetic orientation.

A disk controller 130 is included for controlling the read and write operations to and from the drive, for controlling the speed of the servo motor and the motion of actuator 108, and for providing an interface to and from the host device via a connector such as integrated connector 96 or cable connector 98.

Disk controller 130 includes one or more functions or features of the present invention, as described in further detail in conjunction with the figures that follow.

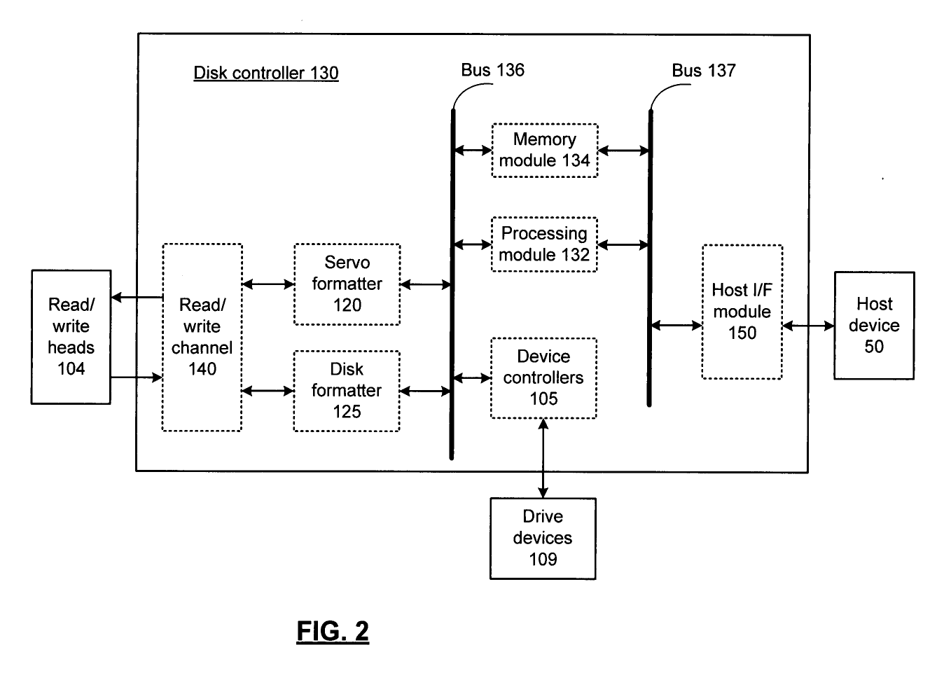

FIG. 2 presents a block diagram representation of a disk controller 130 in accordance with an embodiment of the present invention. In particular, disk controller 130 includes a read/write channel 140 for reading and writing data to and from disk 102 through read/write heads 104. Disk formatter 125 is included for controlling the formatting of data and provides clock signals and other timing signals that control the flow of the data written to, and data read from disk 102, servo formatter 120 provides clock signals and other timing signals based on servo control data read from disk 102, device controllers 105 control the operation of drive devices 109 such as actuator 108 and the servo motor, etc. Host interface module 150 receives read and write commands from host device 50, receives data to be written to the disk 102, transmits data read from disk 102 and provides status along with other control information in accordance with a host interface protocol. In an embodiment of the present invention the host interface protocol can include, Advanced Technology Attachment (ATA)/Integrated Drive Electronics (IDE), Serial ATA (SATA), Fibre channel ATA (FATA), Small Computer System Interface (SCSI), Enhanced IDE (EIDE), MultiMedia Card (MMC), Universal Serial Bus (USB), Serial Attached SCSI (SAS) and Compact Flash (CF) or any number of other host interface protocols, either open or proprietary that can be used for this purpose.

Disk controller 130 further includes a processing module 132 and memory module 134. Processing module 132 can be implemented using one or more microprocessors, micro-controllers, digital signal processors, microcomputers, central processing units, field programmable gate arrays, programmable logic devices, state machines, logic circuits, analog circuits, digital circuits, and/or any devices that manipulates signals (analog and/or digital) based on operational instructions that are stored in memory module 134. When processing module 132 is implemented with two or more devices, each device can perform the same steps, processes or functions in order to provide fault tolerance or redundancy. Alternatively, the function, steps and processes performed by processing module 132 can be split between different devices to provide greater computational speed and/or efficiency.

Memory module 134 may be a single memory device or a plurality of memory devices. Such a memory device may be a read-only memory, random access memory, volatile memory, non-volatile memory, static random access memory (SRAM), dynamic random access memory (DRAM), flash memory, cache memory, and/or any device that stores digital information. Note that when the processing module 132 implements one or more of its functions via a state machine, analog circuitry, digital circuitry, and/or logic circuitry, the memory module 134 storing the corresponding operational instructions may be embedded within, or external to, the circuitry comprising the state machine, analog circuitry, digital circuitry, and/or logic circuitry. Further note that, the memory module 134 stores, and the processing module 132 executes operational instructions to control the operation of drive devices 109, to arbitrate the execution of read and write commands, the flow of data between the host interface module 150 and the read/write channel 140 and to perform other functions of the drive.

Disk controller 130 includes a plurality of modules, in particular, device controllers 105, processing module 132, memory module 134, read/write channel 140, disk formatter 125, servo formatter 120 and host interface module 150 that are interconnected via buses 136 and 137. Each of these modules can be implemented in hardware, firmware, software or a combination thereof, in accordance with the broad scope of the present invention. While a particular bus architecture is shown in FIG. 2 with buses 136 and 137, alternative bus architectures that include either a single bus configuration or additional data buses, further connectivity, such as direct connectivity between the various modules, are likewise possible to implement the features and functions included in the various embodiments of the present invention.

In an embodiment of the present invention, one or more modules of disk controller 130 are implemented as part of a system on a chip integrated circuit. In an embodiment of the present invention, this system on a chip integrated circuit includes a digital portion that can include additional modules such as protocol converters, linear block code encoding and decoding modules, etc., and an analog portion that includes additional modules, such as a power supply, disk drive motor amplifier, disk speed monitor, read amplifiers, etc. In a further embodiment of the present invention, the various functions and features of disk controller 130 are implemented in a plurality of integrated circuit devices that communicate and combine to perform the functionality of disk controller 130.

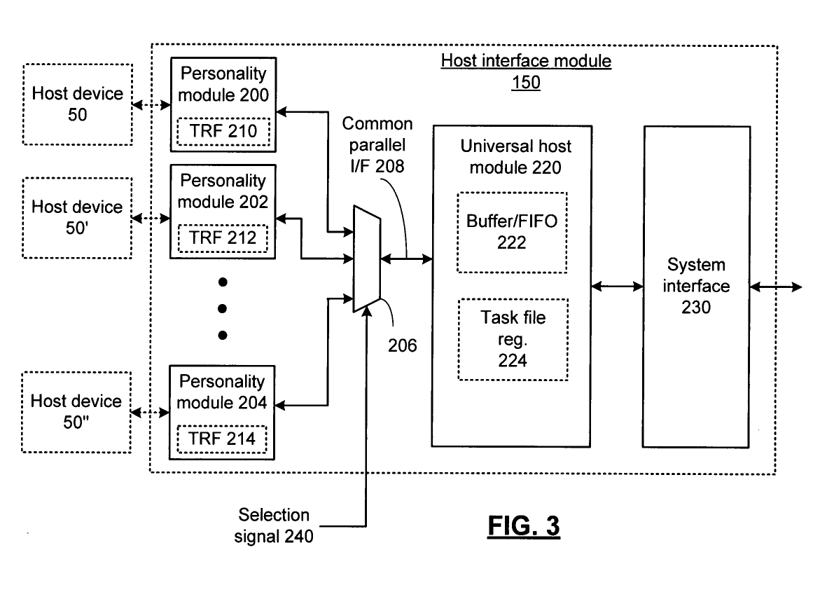

In an embodiment of the present invention, the host interface module includes hardware, software or firmware that implements a plurality of different host interface protocols. This allows disk controller 130 to be designed as a generic device for multiple possible applications with different standard host devices. In this fashion, the host interface module can be configured for a particular application by selecting the particular host interface to be used or by detecting the particular host device connected thereto. Further details regarding host interface module 150 including additional novel features and functions will be described in conjunction with FIG. 3.

FIG. 3 presents a block diagram representation of a host interface module 150 in accordance with an embodiment of the present invention. In particular, host interface module 150 includes a plurality of personality modules 210, 212, 214. Each of the plurality of personality modules, when coupled to a corresponding host device 50, 50′ or 50″, is operable to accept read and write commands and transfer data to and from the corresponding host device in a corresponding one of a plurality of host interface protocols. Multiplexer 206 selectively couples a particular personality module 200, 202 or 204 to the universal host module 220 in response to a selection signal 240. A system interface 230 couples the universal host module 220 to processing module 132 and memory 132 of the disk controller 130, such as via 136 or bus 137. Universal host module 220 decodes read and write commands from a particular host device 50, 50′ and/or 50″ and transports data written to and read from the disk drive unit 100 via the personality module that is coupled to that host device.

In an embodiment of the present invention, each of the plurality of personality modules 200, 202, 204 implements a different host interface protocol such ATA, SATA, FATA, SCSI. IDE, EIDE, MMC, FC, etc. In addition, each of the plurality of personality modules 200, 202, 204 includes a coupling, such as connector 96, cable connector 98 or other connection or coupling, with physical attributes and/or pin configuration selected in accordance with the particular host interface protocol. In this fashion, a host device 50 may communicate with disk drive unit 100 via a personality module 200 that implements a SATA interface that uses a 7-pin connector. In another implementation, a host device 50′ may communicate with disk drive unit 100 via a personality module 202 that implements an ATA/IDE interface with a 40-pin connector. Further, a host device 50″ may communicate with disk drive unit 100 via a personality module 204 that implements an SCSI interface with a 25-pin connector. Selection signal 240 can be set in the factory or by the user to configure the host interface module 130 to operate with a particular host device 50, 50′ or 50″ through the corresponding personality module 200, 202 or 204.

Host interface module 150, as a whole, converts incoming data and commands from the host device 50, 50′ or 50″ in its corresponding host interface protocol, into data and commands in a format used by disk controller 130. Conversely, data from read from disk drive unit 100 is converted by host interface module 150 from the format used by disk drive unit 100 into the particular host interface protocol used by the host device 50, 50′ or 50″. The format used by the disk controller can be a standard format such as Direct Memory Access or any of a variety of other formats that are used for this purpose.

The operation of host interface module 150 can be viewed in terms of four fundamental operations with the host device 50, 50′ and/or 50″: providing a physical layer interface to the host device, providing a link layer interface to the host device, providing a transport layer interface to the host device, and provide command decoding of commands from the host device. As opposed to replicating each of these four functions in separate modules, the personality module 200, 202 and 204 each provide provides physical layer and link layer interface, and the universal host module 220 provides command decoding and transport layer interface between the disk drive and the host device that is attached thereto. In this fashion, the functionality of universal host module 220 need not be replicated, saving potential circuitry, while providing full functionality for each of the corresponding host interface protocols.

In this embodiment of the present invention, multiplexer 206 selectively couples one of the plurality of personality modules to the universal host module via a common parallel interface 208. This common parallel interface 208 conforms to the physical and link layer interface of each of the personality modules 200, 202, and 204. For instance, common parallel interface 208 can include a separate line for each unique signal line of the physical interfaces of each of the personality modules 200, 202 and 204. In this fashion, the common parallel interface includes the union of each of the signal lines present on each of the plurality of personality modules 200, 202 and 204.

In an embodiment, each of the plurality of personality modules 200, 202 and 204 includes a corresponding task file register 210, 212 or 214 that, when coupled to the host device 50, 50′ or 50″, can be written by the host device. The universal host module 220 also includes a task file register 224 that is copied from the task file register 210, 212 or 214, of the selected personality module 200, 202 or 204. This synchronization of task file registers between the personality module(s) and the universal host module 220 allows commands to be passed from the host device. Task file registers 210, 212, and 214 are implemented as specific locations in a memory of host interface module 150 that store commands, such as for DMA transfers of a block of memory. In this implementation, the task file registers 210, 212, and 214 each contain an address field, such as a 16-bit address field and a count field, such as a 16-bit count field, and a data direction, that define the block of data to be transferred and whether the operation is for a read or write. Task file register 224 of universal host module 220 is similarly implemented. Universal host module 220 further includes a buffer/FIFO 222 that buffers the read and write commands from the host device in a buffer order, such as a first-in-first-out order.

In an embodiment of the present invention, host module 150 is implemented with its own host processing engine, implemented using one or more microprocessors, micro-controllers, digital signal processors, microcomputers, central processing units, field programmable gate arrays, programmable logic devices, state machines, logic circuits, analog circuits, digital circuits, and/or any devices that manipulates signal (analog and/or digital) based on operational instructions that are stored in either memory module 134 or its own dedicated memory.

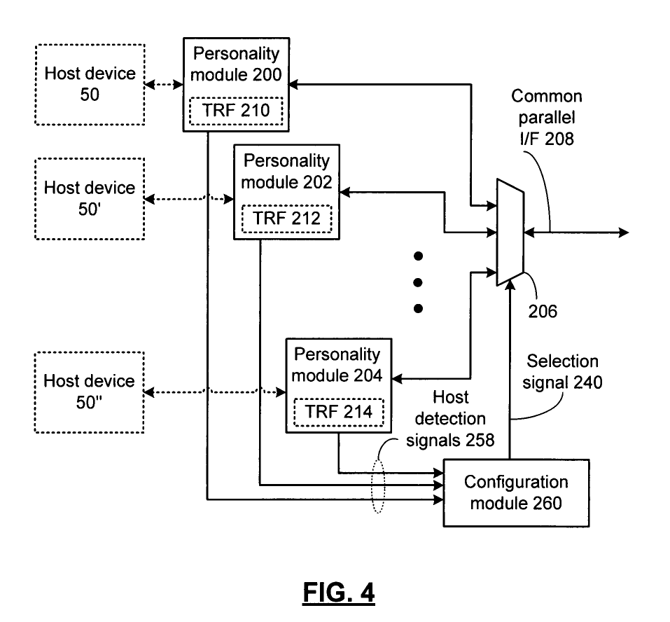

FIG. 4 presents a block diagram representation of a configuration module 260 in accordance with an embodiment of the present invention. In this embodiment, selection signal 240 is automatically generated by configuration module 260 based on the particular host device that is connected to host interface module 150. In particular, each personality module 200, 202, and 204 includes detection circuitry that, based on the presence of supply voltages or signaling generated by the host device, detects that a host device, such as either host device 50, host device 50′ or host device 50″ is coupled thereto. In response, a corresponding one of the plurality of host detection signals 258 is asserted, and selection signal 240 is generated that causes multiplexer 206 to couple the personality module that detected the presence of a host device, to the universal host module 220.

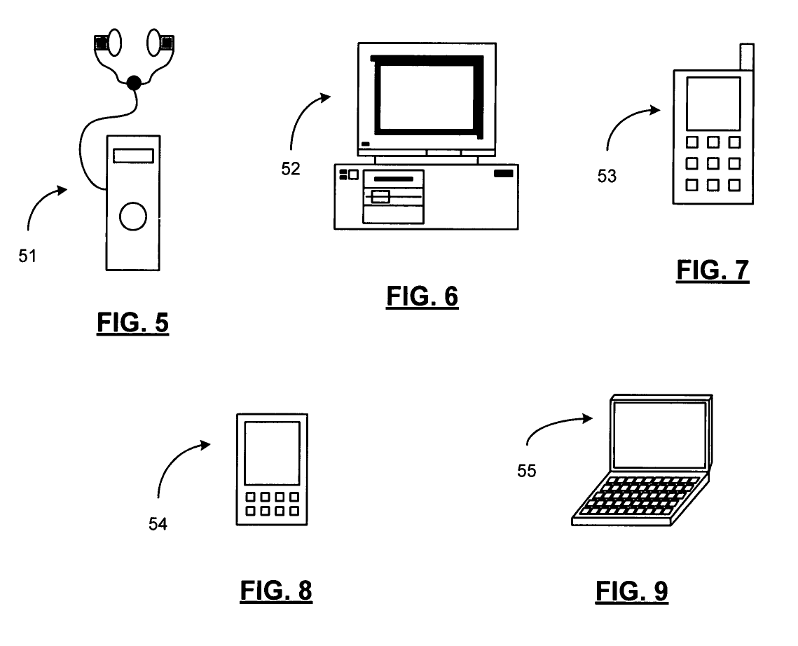

FIG. 5 presents a pictorial representation of a handheld audio unit 51 in accordance with an embodiment of the present invention. In particular, disk drive unit 100 can include a small form factor magnetic hard disk whose disk 102 has a diameter 1.8″ or smaller that is incorporated into or otherwise used by handheld audio unit 51 to provide general storage or storage of audio content such as motion picture expert group (MPEG) audio layer 3 (MP3) files or Windows Media Architecture (WMA) files, video content such as MPEG4 files for playback to a user, and/or any other type of information that may be stored in a digital format.

FIG. 6 presents a pictorial representation of a computer 52 in accordance with an embodiment of the present invention. In particular, disk drive unit 100 can include a small form factor magnetic hard disk whose disk 102 has a diameter 1.8″ or smaller, a 2.5″ or 3.5″ drive or larger drive for applications such as enterprise storage applications. Disk drive unit 100 is incorporated into or otherwise used by computer 52 to provide general purpose storage for any type of information in digital format. Computer 52 can be a desktop computer, or an enterprise storage device such as a server of a host computer that is attached to a storage array such as a redundant array of independent disks (RAID) array, storage router, edge router, storage switch and/or storage director.

FIG. 7 presents a pictorial representation of a wireless communication device 53 in accordance with an embodiment of the present invention. In particular, disk drive unit 100 can include a small form factor magnetic hard disk whose disk 102 has a diameter 1.8″ or smaller that is incorporated into or otherwise used by wireless communication device 53 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats that may be captured by an integrated camera or downloaded to the wireless communication device 53, emails, webpage information and other information downloaded from the Internet, address book information, and/or any other type of information that may be stored in a digital format.

In an embodiment of the present invention, wireless communication device 53 is capable of communicating via a wireless telephone network such as a cellular, personal communications service (PCS), general packet radio service (GPRS), global system for mobile communications (GSM), and integrated digital enhanced network (iDEN) or other wireless communications network capable of sending and receiving telephone calls. Further, wireless communication device 53 is capable of communicating via the Internet to access email, download content, access websites, and provide streaming audio and/or video programming. In this fashion, wireless communication device 53 can place and receive telephone calls, text messages such as emails, short message service (SMS) messages, pages and other data messages that can include attachments such as documents, audio files, video files, images and other graphics.

FIG. 8 presents a pictorial representation of a personal digital assistant 54 in accordance with an embodiment of the present invention. In particular, disk drive unit 100 can include a small form factor magnetic hard disk whose disk 102 has a diameter 1.8″ or smaller that is incorporated into or otherwise used by personal digital assistant 54 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats, emails, webpage information and other information downloaded from the Internet, address book information, and/or any other type of information that may be stored in a digital format.

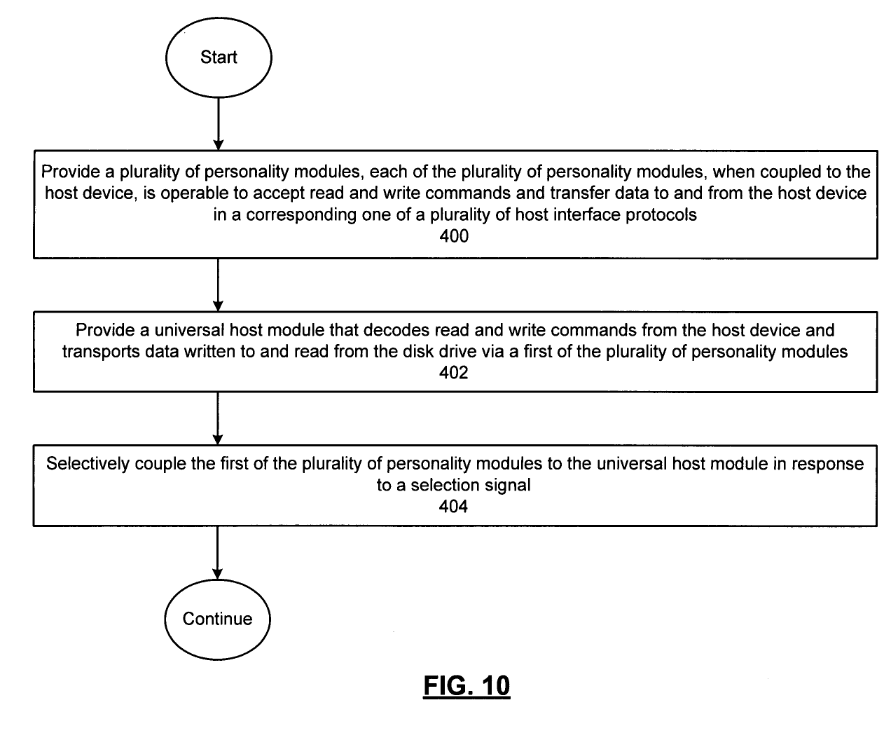

FIG. 9 presents a pictorial representation of a laptop computer 55 in accordance with an embodiment of the present invention. In particular, disk drive unit 100 can include a small form factor magnetic hard disk whose disk 102 has a diameter 1.8″ or smaller, or a 2.5″ drive. Disk drive unit 100 is incorporated into or otherwise used by laptop computer 52 to provide general purpose storage for any type of information in digital format.

FIG. 10 presents a flowchart representation of a method in accordance with an embodiment of the present invention. In particular, a method is presented that can be used in conjunction with one or more of the features or functions described in association with FIGS. 1-9. In step 400, a plurality of personality modules are provided, each of the plurality of personality modules, when coupled to the host device, is operable to accept read and write commands and transfer data to and from the host device in a corresponding one of a plurality of host interface protocols. In step 402, a universal host module is provided that decodes read and write commands from the host device and transports data written to and read from the disk drive via a first of the plurality of personality modules. In step 404, the first of the plurality of personality modules is selectively coupled to the universal host module in response to a selection signal.

In an embodiment of the present invention, step 404 includes selectively coupling the first of the plurality of personality modules to the universal host module via a common parallel interface. The plurality of host interface protocols can include at least two of: AT Attachment (ATA), Serial ATA (SATA), Fibre channel ATA (FATA), Small Computer System Interface (SCSI), Integrated Drive Electronics (IDE), Enhanced IDE (EIDE), MultiMedia Card (MMC), Universal Serial Bus (USB), Serial Attached SCSI (SAS) and Compact Flash (CF).

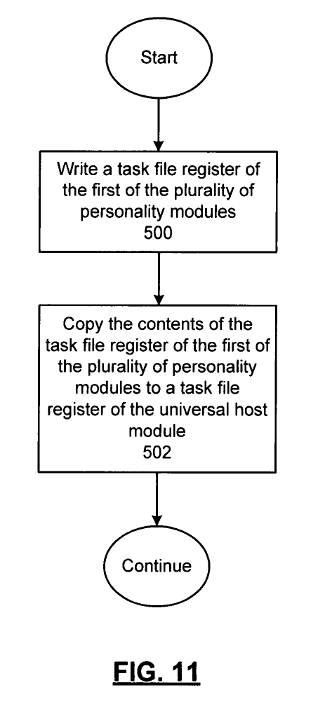

FIG. 11 presents a flowchart representation of a method in accordance with an embodiment of the present invention. In particular, a method is presented that can be used in conjunction with one or more of the features or functions described in association with the method of FIG. 10. In particular, the method of FIG. 11 further comprises the optional step 500 of writing a task file register of the first of the plurality of personality modules, and step 502, of copying contents of the task file register of the first of the plurality of personality modules to a task file register of the universal host module.

While the present invention has been described in terms of a magnetic disk, other nonmagnetic storage devices including optical disk drives including compact disks (CD) drives such as CD-R and CD-RW, digital video disk (DVD) drives such as DVD-R, DVD+R, DVD-RW, DVD+RW, etc can likewise be implemented in accordance with the functions and features of the presented invention described herein.

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to order of magnitude differences. As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”. As one of ordinary skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The various circuit components can be implemented using 0.35 micron or smaller CMOS technology. Provided however that other circuit technologies, both integrated or non-integrated, may be used within the broad scope of the present invention. Likewise, various embodiments described herein can also be implemented as software programs running on a computer processor. It should also be noted that the software implementations of the present invention can be stored on a tangible storage medium such as a magnetic or optical disk, read-only memory or random access memory and also be produced as an article of manufacture.

Thus, there has been described herein an apparatus and method, as well as several embodiments including a preferred embodiment, for implementing a disk controller and host interface module. Various embodiments of the present invention herein-described have features that distinguish the present invention from the prior art.

It will be apparent to those skilled in the art that the disclosed invention may be modified in numerous ways and may assume many embodiments other than the preferred forms specifically set out and described above. Accordingly, it is intended by the appended claims to cover all modifications of the invention which fall within the true spirit and scope of the invention.

What is claimed is:

1. A disk controller for use in a disk drive, the disk controller comprising:
a read/write channel module, operably coupled to the processor and the memory, for writing data to and reading data from the disk drive;
a host module that includes:
a plurality of personality modules, each of the plurality of personality modules, when coupled to one of a first host device, is operable to accept read and write commands and transfer data to and from the first host device in a corresponding one of a plurality of host interface protocols;
a universal host module that decodes read and write commands from the first host device and transports data written to and read from the disk drive via a first of the plurality of personality modules;
a multiplexer that selectively couples the first of the plurality of personality modules to the universal host module in response to a selection signal; and
a system interface for coupling the universal host module to a processor and a memory of the disk controller; and
a memory that stores operational instructions;
a processor, operably coupled to the memory, the host module and the read/write channel, for executing the operational instructions to control the operation of a plurality of drive devices, to arbitrate the execution of read and write commands and the flow of data between the host module and the read/write channel.

2. The disk controller of claim 1 wherein the multiplexer selectively couples the first of the plurality of personality modules to the universal host module via a common parallel interface.

3. The disk controller of claim 1 wherein the first of the plurality of personality modules is further coupled to a second host device, the universal host module further decodes read and write commands from the first host device and the second host device and transports data read from the disk drive at least one of the first host device and the second host device via the first of the plurality of personality modules.

4. The disk controller of claim 1 wherein the first of the plurality of personality modules provides physical layer and link layer interface, and the universal host module provides command layer and transport layer interface between the disk drive and the first host device.

5. The disk controller of claim 1 wherein the plurality of host interface protocols include at least two of: AT Attachment (ATA), Serial ATA (SATA), Fibre channel ATA (FATA), Small Computer System Interface (SCSI), Integrated Drive Electronics (IDE), Enhanced IDE (EIDE), MultiMedia Card (MMC), Universal Serial Bus (USB), Serial Attached SCSI (SAS) and Compact Flash (CF).

6. The disk controller of claim 1 wherein the first of the plurality of personality modules includes a task file register that, when coupled to the first host device, is written by the first host device.

7. The disk controller of claim 6 wherein the universal host module includes a task file register that is copied from the task file register of the first of the plurality of personality modules.

8. The disk controller of claim 1 wherein the universal host module includes a first-in-first-out buffer that buffers read and write data from the first host device.

9. A host interface module for use in a disk controller of a disk drive, the host interface module operable to couple the disk drive to a first host device, the host interface module comprising:
a plurality of personality modules, each of the plurality of personality modules, when coupled to the first host device, is operable to accept read and write commands and transfer data to and from the first host device in a corresponding one of a plurality of host interface protocols;
a universal host module that decodes read and write commands from the first host device and transports data written to and read from the disk drive via a first of the plurality of personality modules;
a multiplexer that selectively couples the first of the plurality of personality modules to the universal host module in response to a selection signal; and
a system interface that couples the universal host module to a processor and a memory of the disk controller.

10. The host interface module of claim 9 wherein the multiplexer selectively couples the first of the plurality of personality modules to the universal host module via a common parallel interface.

11. The host interface module of claim 9 wherein the first of the plurality of personality modules is further coupled to a second host device, the universal host module further decodes read and write commands from the first host device and the second host device and transports data read from the disk drive at least one of the first host device and the second host device via the first of the plurality of personality modules.

12. The host interface module of claim 9 wherein the first of the plurality of personality modules provides physical layer and link layer interface, and the universal host module provides command layer and transport layer interface between the disk drive and the first host device.

13. The host interface module of claim 9 wherein the plurality of host interface protocols include at least two of: AT Attachment (ATA), Serial ATA (SATA), Fibre channel ATA (FATA), Small Computer System Interface (SCSI), Integrated Drive Electronics (IDE), Enhanced IDE (EIDE), MultiMedia Card (MMC), Universal Serial Bus (USB), Serial Attached SCSI (SAS) and Compact Flash (CF).

14. The host interface module of claim 9 wherein the first of the plurality of personality modules includes a task file register that, when coupled to the first host device, is written by the first host device.

15. The host interface module of claim 14 wherein the universal host module includes a task file register that is copied from the task file register of the first of the plurality of personality modules.

16. The host interface module of claim 9 wherein the universal host module includes a first-in-first-out buffer that buffers read and write data from the host device.

17. A method for use in a disk controller of a disk drive, the method comprising:
providing a plurality of personality modules, each of the plurality of personality modules, when coupled to the host device, is operable to accept read and write commands and transfer data to and from the host device in a corresponding one of a plurality of host interface protocols;
providing a universal host module that decodes read and write commands from the host device and transports data written to and read from the disk drive via a first of the plurality of personality modules; and
selectively coupling the first of the plurality of personality modules to the universal host module in response to a selection signal.

18. The method of claim 17 further comprising the step of:
writing a task file register of the first of the plurality of personality modules.

19. The method of claim 18 further comprising the step of:
copying contents of the task file register of the first of the plurality of personality modules to a task file register of the universal host module.

20. The method of claim 17 wherein the step of selectively coupling includes selectively coupling the first of the plurality of personality modules to the universal host module via a common parallel interface.

21. The method of claim 17 wherein the plurality of host interface protocols include at least two of: AT Attachment (ATA), Serial ATA (SATA), Fibre channel ATA (FATA), Small Computer System Interface (SCSI), Integrated Drive Electronics (IDE), Enhanced IDE (EIDE), MultiMedia Card (MMC), Universal Serial Bus (USB), Serial Attached SCSI (SAS) and Compact Flash (CF).
